(19) United States
(12) Patent Application Publication
(10) Pub. No.: US 2025/0343585 A1
(43) Pub. Date: Nov. 6, 2025

(54) CSI TRANSMISSION METHOD AND APPARATUS, TERMINAL, AND NETWORK SIDE DEVICE

(71) Applicant: VIVO MOBILE COMMUNICATION CO., LTD., Guangdong (CN)

(72) Inventors: Qianyao REN, Guangdong (CN); Hao WU, Guangdong (CN); Tian XIE, Guangdong (CN); Peng SUN, Guangdong (CN)

(73) Assignee: VIVO MOBILE COMMUNICATION CO., LTD., Guangdong (CN)

(21) Appl. No.: 19/266,703

(22) Filed: Jul. 11, 2025

Related U.S. Application Data
(63) Continuation of application No. PCT/CN2024/070709, filed on Jan. 5, 2024.

(30) Foreign Application Priority Data
Jan. 12, 2023 (CN) 202310039066.0

(51) Int. Cl. H04B 7/06; H04L 5/00; H04L 41/16; H04W 24/10; H04W 72/21

(52) U.S. Cl. CPC H04B 7/0626; H04L 5/0005; H04L 41/16; H04W 24/10; H04W 72/21

(57) ABSTRACT

A CSI transmission method and apparatus, a terminal, and a network side device. The CSI transmission method in the embodiments of this application includes: obtaining, by a terminal, first information, where the first information indicates a reporting location of first CSI, and the first CSI is CSI used for monitoring performance of an artificial intelligence (AI) unit; and reporting, by the terminal based on the first information, the first CSI, or reporting the first CSI and second CSI, where the second CSI is CSI obtained based on the AI unit.

### CROSS-REFERENCE TO RELATED APPLICATIONS

This application is a continuation of International Application No. PCT/CN2024/070709 filed on Jan. 5, 2024, which claims priority to Chinese Patent Application No. 202310039066.0 filed on Jan. 12, 2023, which are incorporated herein by reference in their entireties.

### TECHNICAL FIELD

This application belongs to the field of communication technologies, and in particular, to a CSI transmission method and apparatus, a terminal, and a network side device.

### BACKGROUND

With the development of science and technology, people have started to study application of an artificial intelligence (AI) network technology in a communication system. For example, communication data may be transmitted between a network side device and a terminal by using an AI network model. AI model-based channel state information (CSI) compression is divided into a coding model and a decoding model. Generally, the coding model is on a terminal side, and the decoding model is on a base station side. Without the decoding model, the terminal cannot obtain channel information reconstructed by the base station, and cannot compare original channel information with the reconstructed channel information. It needs to obtain both the coding model and the decoding model on one side to calculate a final reasoning result of the model. However, obtaining the coding model and the decoding model on one side may cause large transmission overheads between the terminal and the base station.

### SUMMARY

Embodiments of this application provide a CSI transmission method and apparatus, a terminal, and a network side device.

According to a first aspect, a CSI transmission method is provided, including:
obtaining, by a terminal, first information, where the first information indicates a reporting location of first CSI, and the first CSI is CSI used for monitoring performance of an artificial intelligence (AI) unit; and
reporting, by the terminal based on the first information, the first CSI, or reporting the first CSI and second CSI, where the second CSI is CSI obtained based on the AI unit.

According to a second aspect, a CSI transmission method is provided, including:
receiving, by a network side device, first CSI reported by a terminal based on first information, or receiving the first CSI and second CSI reported by the terminal based on the first information, where
the first information indicates a reporting location of the first CSI, the first CSI is CSI used for monitoring performance of an AI unit, and the second CSI is CSI obtained based on the AI unit.

According to a third aspect, a CSI transmission apparatus is provided, including:
an obtaining module, configured to obtain first information, where the first information indicates a reporting location of first CSI, and the first CSI is CSI used for monitoring performance of an AI unit; and
a reporting module, configured to report the first CSI or report the first CSI and second CSI based on the first information, where the second CSI is CSI obtained based on the AI unit.

According to a fourth aspect, a CSI transmission apparatus is provided, including:
a receiving module, configured to: receive first CSI reported by a terminal based on first information, or receive the first CSI and second CSI reported by the terminal based on the first information, where
the first information indicates a reporting location of the first CSI, the first CSI is CSI used for monitoring performance of an AI unit, and the second CSI is CSI obtained based on the AI unit.

According to a fifth aspect, a terminal is provided. The terminal includes a processor and a memory, the memory stores a program or an instruction that can be run on the processor, and the program or the instruction is executed by the processor to implement the steps of the CSI transmission method according to the first aspect.

According to a sixth aspect, a terminal is provided, including a processor and a communication interface. The processor is configured to obtain first information, where the first information indicates a reporting location of first CSI, and the first CSI is CSI used for monitoring performance of an AI unit; and the communication interface is configured to report the first CSI or report the first CSI and second CSI based on the first information, where the second CSI is CSI obtained based on the AI unit.

According to a seventh aspect, a network side device is provided. The network side device includes a processor and a memory, the memory stores a program or an instruction that can be run on the processor, and the program or the instruction is executed by the processor to implement the steps of the CSI transmission method according to the second aspect.

According to an eighth aspect, a network side device is provided, including a processor and a communication interface. The communication interface is configured to: receive first CSI reported by a terminal based on first information, or receive the first CSI and second CSI reported by the terminal based on the first information, where the first information indicates a reporting location of the first CSI, the first CSI is CSI used for monitoring performance of an AI unit, and the second CSI is CSI obtained based on the AI unit.

According to a ninth aspect, a communication system is provided, including a terminal and a network side device. The terminal may be configured to perform the steps of the CSI transmission method according to the first aspect, and the network side device may be configured to perform the steps of the CSI transmission method according to the second aspect.

According to a tenth aspect, a readable storage medium is provided, where the readable storage medium stores a program or an instruction, and the program or the instruction is executed by a processor to implement the steps of the CSI transmission method according to the first aspect or the steps of the CSI transmission method according to the second aspect.

According to an eleventh aspect, a chip is provided. The chip includes a processor and a communication interface, the communication interface is coupled to the processor, and the processor is configured to run a program or an instruction to implement the CSI transmission method according to the first aspect or implement the CSI transmission method according to the second aspect.

According to a twelfth aspect, a computer program product is provided. The computer program product is stored in a storage medium, and the computer program product is executed by at least one processor to implement the steps of the CSI transmission method according to the first aspect or the steps of the CSI transmission method according to the second aspect.

### BRIEF DESCRIPTION OF DRAWINGS

FIG. 1 is a block diagram of a wireless communication system to which the embodiments of this application are applicable;

FIG. 2 is a flowchart of a CSI transmission method according to an embodiment of this application;

FIG. 3 is a flowchart of another CSI transmission method according to an embodiment of this application;

FIG. 4 is a structural diagram of a CSI transmission apparatus according to an embodiment of this application;

FIG. 5 is a structural diagram of another CSI transmission apparatus according to an embodiment of this application;

FIG. 6 is a structural diagram of a communication device according to an embodiment of this application;

FIG. 7 is a structural diagram of a terminal according to an embodiment of this application; and

FIG. 8 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. A new radio (NR) system is described in the following description for illustrative purposes, and the NR terminology is used in most of the following description, although these technologies can also be applied to applications other than the NR system application, such as the 6^{th} generation (6G) communication system.

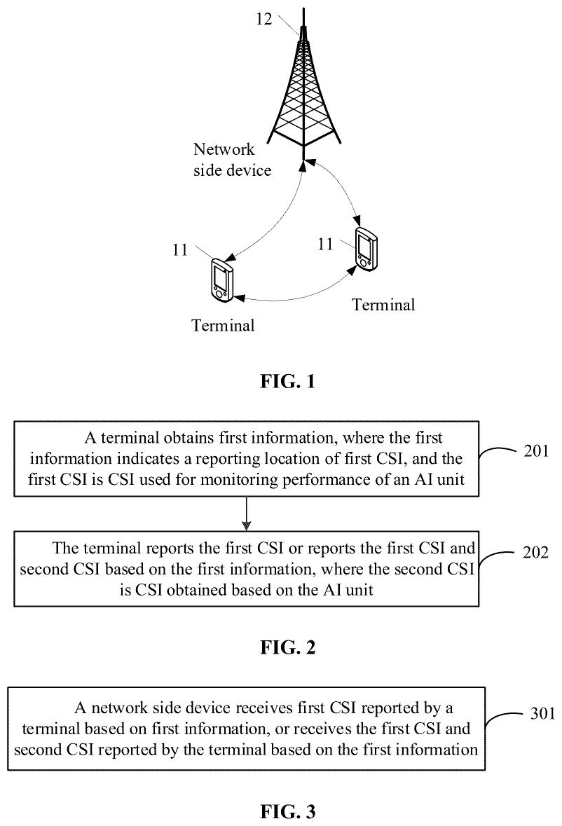

FIG. 1 is a block diagram of a wireless communication system to which the embodiments of this application are applicable. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart household (household devices with wireless communication functions, such as a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart bangle, a smart anklet, and the like), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (Transmission Reception Point, TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (PCRF), an edge application service discovery function (EASDF), unified data management (UDM), unified data repository (UDR), a home subscriber server (HSS), centralized network configuration (CNC), a network repository function (NRF), a network exposure function (NEF), a local NEF (L-NEF), a binding support function (BSF), an application function (AF), and the like. It should be noted that, in the embodiments of this application, only a core network device in an NR system is used as an example for description, and a specific type of the core network device is not limited.

To facilitate understanding of the technical solutions in the embodiments of this application, the following first explains some concepts and principles used in the embodiments of this application.

It can be learned from information theory that accurate channel state information (CSI) is crucial for a channel capacity. In particular, for a multi-antenna system, a transmit end may optimize signal sending based on CSI, so that signal sending matches a channel status to a larger degree. For example, a channel quality indicator (CQI) may be used to select a proper modulation and coding scheme (MCS) to implement link adaptation, and a precoding matrix indicator (PMI) may be used to implement eigen beamforming to maximize received signal strength or to suppress interference (for example, inter-cell interference or multi-user interference). Therefore, CSI acquisition has always been a research hotspot since a multi-antenna technology (multi-input multi-output, MIMO) was proposed.

Generally, a base station sends a channel state information reference signal (CSI-RS) on some time-frequency resources of a slot. The terminal performs channel estimation based on the CSI-RS, calculates channel information on the slot, and feeds back a PMI to the base station by using a codebook. The base station combines codebook information fed back by the terminal to form channel information. Before next CSI reporting, the base station performs data precoding and multi-user scheduling by using the channel information.

To further reduce CSI feedback overheads, the terminal may change “reporting a PMI on each sub-band” into a “reporting a PMI based on a delay”. Because channels in a delay domain are more centralized, PMIs of all sub-bands may be approximately represented by using PMIs of fewer delays, that is, information of the delay domain is compressed before being reported.

Similarly, to reduce overheads, the base station may precode the CSI-RS in advance, and send a coded CSI-RS to the terminal. What is observed by the terminal is a channel corresponding to the coded CSI-RS. The terminal only needs to select several ports of relatively high strength from ports indicated by a network side, and report coefficients corresponding to these ports.

Further, to better compress channel information, a neural network or a machine learning method may be used by the terminal and the network side device to transmit channel information.

Specifically, the terminal compresses and codes the channel information by using an AI model, and the base station decodes compressed content by using a corresponding AI model, to reconstruct the channel information. In this case, the AI model for decoding on a base station side and the AI model for coding on a terminal side need to be jointly trained to achieve a proper degree of matching. An input of the coding AI model is channel information, and an output is coded information, that is, channel characteristic information. An input of the decoding AI model is coded information, and an output is reconstructed channel information.

A main evaluation index of the AI model is correlation between input channel information and reconstructed channel information. If the input channel information and the reconstructed channel information are identical, it indicates that the AI model achieves perfect compression. The AI model may be usually considered as effective when a correlation loss is within a certain extent. If the correlation loss exceeds a conventional non-AI method, such as a type 2 (TypeII) codebook, the AI model may be replaced with a conventional codebook.

As described above, AI model-based CSI compression is divided into the coding AI model and the decoding AI model. Generally, the coding AI model is on a terminal side, and the decoding AI model is on a network side device. Without the decoding AI model, the terminal cannot obtain channel information reconstructed by the network side device, and cannot compare original channel information with the reconstructed channel information. Therefore, monitoring on the AI model needs to be performed on the network side device. However, the network side device has the reconstructed channel information but no original channel information, so it is impossible to compare. Therefore, to monitor a reconstructed result of the AI model on the network side device, the terminal needs to provide the original channel information. However, reporting of the original channel information needs large overheads, which may lead to an increase of transmission overheads between the terminal and the network side device. In view of these situations, an embodiment of this application proposes a CSI transmission method.

The following describes in detail the CSI transmission method provided in this embodiment of this application through some embodiments and application scenarios thereof with reference to the accompanying drawings.

Referring to FIG. 2, FIG. 2 is a flowchart of a CSI transmission method according to an embodiment of this application. The method is applied to a terminal. As shown in FIG. 2, the method includes the following steps.

Step 201: A terminal obtains first information, where the first information indicates a reporting location of first CSI, and the first CSI is CSI used for monitoring performance of an AI unit.

Optionally, the first information may be sent by a network side device, the network side device indicates the reporting location of the first CSI by using the first information, and the terminal can determine the reporting location of the first CSI based on the first information, so that the terminal can report the first CSI at the reporting location.

The first CSI is CSI for monitoring the performance of the AI unit, for example, the first CSI may be CSI obtained in a non-AI manner, such as CSI obtained through calculation based on a codebook. It should be noted that the AI unit may also be referred to as an AI model, an AI structure, and the like, or the AI unit may also refer to a processing unit that can realize a specific algorithm, formula, processing flow, and the like related to AI. This is not specifically limited in this embodiment of this application. The performance of the AI unit may refer to model accuracy, a model loss, a reconstructing degree for channel information, and the like of the AI unit.

Step 202: The terminal reports the first CSI or reports the first CSI and second CSI based on the first information, where the second CSI is CSI obtained based on the AI unit.

It may be understood that, if the first information indicates the reporting location of the first CSI, the terminal may report the first CSI based on the first information, that is, report CSI used for monitoring the AI unit. After receiving the first CSI, the network side device may compare the first CSI with channel information reconstructed by the network side device by using the AI unit, to obtain the performance of the AI unit.

It should be noted that the terminal side includes a first AI unit, the first AI unit is configured to perform coding processing on original channel information, and then output channel characteristic information, and the terminal reports the channel characteristic information, that is, sends the channel characteristic information to the network side device; and the network side device includes a second AI unit, the network side device uses the channel characteristic information as an input of the second AI unit, and the second AI unit performs decoding processing on the channel characteristic information, and then outputs reconstructed channel information. In this way, the terminal and the network side device can transmit the channel information based on the first AI unit and the second AI unit.

In this embodiment of this application, the second CSI may be CSI obtained based on the first AI unit, the terminal may alternatively report the first CSI and the second CSI, and the network side device may use the second CSI as the input of the second AI unit and obtain channel information that is output by the second AI unit. Further, the network side device may reconstruct the channel information by using the first CSI, and compare reconstructed channel information with the channel information that is output by the second AI unit, to determine performance of the second AI unit, for example, a degree of reconstructing the channel information by the second AI unit may be determined.

In this embodiment of this application, the terminal reports the first CSI used for monitoring the performance of the AI unit, or reports the first CSI and the second CSI obtained based on the AI unit, where the first CSI is CSI obtained in a non-AI manner, so that the network side device can compare the first CSI with the channel information reconstructed by the AI unit, to determine a degree of reconstructing the channel information by the AI unit. In this way, the performance of the AI unit can be learned, which is helpful for the network side device to switch from a failed or low-performance AI unit in time based on the performance of the AI unit, or to change a CSI transmission mode, thereby more effectively ensuring CSI transmission between the terminal and the network side device. In addition, the terminal reports the first CSI obtained in a non-AI manner, so that the network side device can finally determine the performance of the AI unit based on the first CSI. In this way, there is no need to transmit the AI unit between the terminal and the network side device to determine the performance of the AI unit. This effectively reduces transmission overheads between the terminal and the network side device.

Optionally, the first information further indicates a reporting location of the second CSI. For example, the first information sent by the network side device further indicates the reporting location of the second CSI, so that the terminal can report the second CSI at a corresponding location based on the first information. In this way, the reporting locations of the second CSI obtained based on AI and the first CSI obtained based on non-AI are determined by using the first information, which effectively standardizes reporting of the first CSI and the second CSI.

In this embodiment of this application, that a terminal obtains first information includes any one of the following:
obtaining, by the terminal, a first CSI report configuration configured by a network side device, where the first CSI report configuration indicates the reporting location of the first CSI and the reporting location of the second CSI;
obtaining, by the terminal, a second CSI report configuration and/or a third CSI report configuration configured by the network side device, where the second CSI report configuration indicates the reporting location of the second CSI, and the third CSI report configuration indicates the reporting location of the first CSI; and
receiving, by the terminal, first indication information sent by the network side device, where the first indication information indicates at least one of the following:
a first CSI report configuration identity (ID), where the first CSI report configuration ID indicates a location of a reference signal (RS) corresponding to the second CSI;
a CSI-RS resource, where the CSI-RS resource is associated with the reporting location of the first CSI and the reporting location of the second CSI;
a time-frequency location in which the first CSI is reported and/or a time-frequency location in which the second CSI is reported; and
configuration information of a codebook, where CSI reported by the terminal is reported by using codebook-based channel information.

Optionally, in an implementation, the network side device configures a CSI report configuration (that is, the first CSI report configuration), and indicates the reporting location of the first CSI and the second reporting location simultaneously by using the first CSI report configuration (report config).

Alternatively, in another implementation, the network side device configures two CSI report configurations (namely, the second CSI report configuration and a third CSI report configuration), and indicates the reporting location of the second CSI and the reporting location of the first CSI respectively by using these two CSI report configurations. In this way, the reporting location of the CSI obtained based on AI and the reporting location of the CSI obtained in a non-AI manner are indicated by using different CSI report configurations, to further standardize a reporting manner of CSI. It should be noted that, alternatively, the network side device may configure only the second CSI report configuration or the third CSI report configuration, for example, the network side device may configure only the third CSI report configuration to indicate the reporting location of the first CSI used for monitoring the performance of the AI unit, and the terminal may still report the second CSI obtained based on the AI unit in a normal reporting manner.

Alternatively, in another implementation, by using the first indication information, the network side device may directly indicate a CSI report configuration identity (ID), or indicate a CSI-RS resource, or directly indicate a time-frequency location in which the first CSI is reported and/or a time-frequency location in which the second CSI is reported. The terminal finds, based on the first indication information of the network side device, the corresponding time-frequency location for channel detection, or calculates, by using channel information buffered in the corresponding location before, CSI information obtained in a non-AI manner for reporting.

Alternatively, if CSI reported by the terminal (the first CSI, or the first CSI and the second CSI) is reported by using codebook-based channel information, the first indication information sent by the network side device may further indicate configuration information of the codebook. Further, the network side device determines, by indicating the configuration information of the codebook, a form of the CSI reported by the terminal by using the codebook-based channel information.

Optionally, in a case that the first indication information indicates the configuration information of the codebook, the configuration information of the codebook includes a second parameter for indicating a first parameter, the first parameter includes a non-zero coefficient bitmap and/or a non-zero coefficient matrix, and the second parameter includes at least one of the following:
a rank indicator;
a quantity of beams selected by the terminal;
a quantity of delays selected by the terminal;
a quantity of non-zero coefficients; and
a proportion of non-zero coefficients to overall coefficients.

Optionally, in a case that the configuration information of the codebook is indicated by using a higher-layer parameter, a higher-layer parameter corresponding to the first parameter is related to a value of the second parameter. For example, if the value of the second parameter varies, a higher-layer parameter corresponding to the non-zero coefficient bitmap may vary. Furthermore, a higher-layer parameter corresponding to the first parameter can be indicated correspondingly based on the value of the second parameter.

It should be noted that, in a case that the network side device configures a CSI report configuration (that is, the first CSI report configuration), the first CSI report configuration ID further indicates the reporting location of the second CSI. It may be understood that, the first CSI report configuration ID may correspond to the reporting location of the second CSI, that is, different IDs correspond to different reporting locations. In this way, the reporting location of the second CSI can be indicated by using the first CSI report configuration ID. Therefore, the reporting location of the second CSI does not need to be indicated additionally, and transmission overheads can be effectively reduced.

Optionally, the first CSI report configuration includes at least one of the following:
a first CSI resource, where the first CSI resource is used for calculating the first CSI and the second CSI, and the first CSI and the second CSI correspond to a same CSI-RS; and
the first CSI and the second CSI are associated with a same CSI reference resource.

In this embodiment of this application, in a case that the network side device configures only one CSI report configuration, reporting of the first CSI and reporting of second CSI correspond to the same CSI-RS, there is one CSI resource in the CSI report configuration, that is, the first CSI resource, and the first CSI resource is used for calculating both the first CSI and the second CSI.

Alternatively, reporting of the first CSI and reporting of the second CSI are associated with a same CSI reference resource. It should be noted that, the CSI reference resource is used for a time-frequency location of the CSI-RS corresponding to the CSI, and reporting of each CSI may be associated with a CSI reference resource. A CSI-RS calculated by the CSI is sent before a time domain location corresponding to the CSI reference resource and within a frequency domain location corresponding to the CSI reference resource.

Optionally, in a case that the first CSI and the second CSI correspond to the same CSI-RS, the reporting, by the terminal based on the first information, the first CSI and second CSI determining, by the terminal based on the first CSI report configuration, a time domain location of the CSI-RS corresponding to the first CSI and the second CSI; and reporting, by the terminal, the first CSI and the second CSI after the time domain location of the CSI-RS.

To be specific, in a case that the first CSI and the second CSI correspond to the same CSI-RS, the reporting locations of the first CSI and the second CSI are after the time domain location of the CSI-RS.

Optionally, in a case that the first CSI and the second CSI are associated with a same CSI reference resource, the method further includes:
determining, by the terminal, a first CSI reference resource based on the reporting location of the second CSI; and
associating the first CSI with the first CSI reference resource.

In this embodiment of this application, the terminal determines a CSI reference resource based on the reporting location of the second CSI determined based on AI, and then associates the first CSI used for monitoring the performance of the AI unit with the CSI reference resource, to associate the first CSI and the second CSI with the same CSI reference resource.

Optionally, a time domain location corresponding to the first CSI reference resource is before or after a time domain location of the first CSI report configuration.

Optionally, in a case that the first CSI and the second CSI are associated with a same CSI reference resource, the first CSI corresponds to a first CSI-RS, the second CSI corresponds to a second CSI-RS, and the first CSI-RS is associated with the second CSI-RS. That is, the first CSI-RS and the second CSI-RS may be different, but are associated with each other, for example, having a same quasi co-location (QCL) or transmission configuration indicator (TCI) state.

In this embodiment of this application, in a case that the network side device configures only one CSI report configuration (that is, the first CSI report configuration), the first CSI report configuration may include two CSI-RS indicators.

Optionally, the first CSI report configuration includes at least one of the following:
a first CSI resource configuration (resource config) and a second CSI resource configuration, where the first CSI resource configuration corresponds to the first CSI, and the second CSI resource configuration corresponds to the second CSI;
a first CSI resource configuration, where the first CSI resource configuration includes a first CSI-RS resource set list and a second CSI-RS resource set list, the first CSI-RS resource set list corresponds to the first CSI, and the second CSI-RS resource set list corresponds to the second CSI; that is, reporting of the first CSI and reporting of the second CSI correspond to different CSI-RS resource set lists of a CSI resource config;
a first CSI resource configuration, where the first CSI resource configuration includes a first CSI-RS resource set list, the first CSI-RS resource set list includes a first CSI-RS resource set and a second CSI-RS resource set, the first CSI-RS resource set corresponds to the first CSI, and the second CSI-RS resource set corresponds to the second CSI; that is, reporting of the first CSI and reporting of the second CSI correspond to different CSI-RS resource sets in a CSI-RS resource set list in a same CSI resource config;
a first CSI resource configuration, where the first CSI resource configuration includes a first CSI-RS resource set list, the first CSI-RS resource set list includes a first CSI-RS resource set, the first CSI-RS resource set includes a first CSI-RS and a second CSI-RS, the first CSI-RS corresponds to the first CSI, and the second CSI-RS corresponds to the second CSI; that is, reporting of the first CSI and reporting of the second CSI correspond to different CSI-RSs in a CSI-RS resource set in a CSI-RS resource set list in a same CSI resource config;
a time-frequency location in which the first CSI is reported and a time-frequency location in which the second CSI is reported; and
a bandwidth part (BWP) in which the first CSI is reported and a bandwidth part in which the second CSI is reported.

Optionally, in a case that the first CSI report configuration includes the first CSI resource configuration and the second CSI resource configuration, the first CSI resource configuration and the second CSI resource configuration further satisfy at least one of the following:
(1). corresponding resource types are different, for example, the second CSI obtained based on the AI unit is periodic or semi-persistent, and the first CSI is aperiodic; and
(2). included CSI-RS resource set lists are different, that is, different CSI-RS are used.

Optionally, in a case that the first CSI report configuration includes a first CSI resource configuration, and the first CSI resource configuration includes a first CSI-RS resource set list and a second CSI-RS resource set list, the first CSI-RS resource set list is an expanded resource set list of CSI for indicating to calculate the performance of the AI unit. In this case, that is, the first CSI has an independent CSI-RS resource set list, including a required CSI-RS resource set. In this case, types of the first CSI-RS resource set list need to be expanded, that is, to expand a set list for indicating to calculate the performance of the AI unit.

Optionally, in a case that the first CSI report configuration includes a first CSI resource configuration, the first CSI resource configuration includes a first CSI-RS resource set list, and the first CSI-RS resource set list includes a first CSI-RS resource set and a second CSI-RS resource set, the first CSI-RS resource set and the second CSI-RS resource set further satisfy at least one of the following:
(1). content of the first CSI-RS resource set is the same as content of the second CSI-RS resource set, and a CSI-RS in the first CSI-RS resource set is used for calculating both the first CSI and the second CSI, that is, a CSI-RS needs to calculate both the first CSI and the second CSI;
(2). the first CSI-RS resource set is associated with the second CSI-RS resource set, and the content of the first CSI-RS resource set is different from the content of the second CSI-RS resource set, that is, the first CSI-RS resource set and the second CSI-RS resource set are different, but are associated with each other, for example, having a same QCL and the like; and
(3). the first CSI-RS resource set and the second CSI-RS resource set are specified by a protocol, for example, it is specified in the protocol which resource sets are used for the first CSI and which are used for the second CSI, such as a last resource set is used for the first CSI, and others are used for the second CSI, or odd-numbered resource sets are used for the first CSI, even-numbered resource sets are used for the second CSI, and the like.

In this embodiment of this application, the network side device may alternatively configure two CSI report configurations to indicate the reporting location of the first CSI and the reporting location of the second CSI respectively.

Optionally, in a case that the network side device configures a second CSI report configuration and a third CSI report configuration, where the second CSI report configuration indicates the reporting location of the second CSI, and the third CSI report configuration indicates the reporting location of the first CSI, the third CSI report configuration includes a CSI report configuration ID, and the method further includes:
performing, by the terminal, channel estimation based on a CSI-RS resource in a CSI report configuration corresponding to the CSI report configuration ID.

That is, the third CSI report configuration may carry a CSI report config ID, and the terminal may use the CSI-RS resource in the CSI report config corresponding to the ID for channel estimation.

It should be noted that the second CSI report configuration and the third CSI report configuration may be configured to the terminal by the network side device before CSI detection.

Alternatively, the third CSI report configuration may be configured after CSI detection. In this case, the network side device needs to notify the terminal of monitoring the performance of the AI unit, and the terminal starts to buffer a channel measurement result. Subsequently, the network side device configures the third CSI report configuration carrying a historical CSI report config 1D, and the terminal uses a buffered channel matrix to calculate corresponding codebook-based CSI information for reporting.

Optionally, before the obtaining, by the terminal, a second CSI report configuration and/or a third CSI report configuration configured by the network side device, the method further includes:
receiving, by the terminal, second indication information sent by the network side device, where the second indication information indicates the terminal to report CSI information.

For example, in a case that the third CSI report configuration is configured to the terminal after CSI detection, the network side device may send the second indication information to the terminal, to notify the terminal that the performance of the AI unit needs to be monitored, and the terminal reports the first CSI and the second CSI based on the second indication information.

Optionally, the reporting, by the terminal based on the first information, the first CSI includes:
calculating, by the terminal, corresponding codebook-based CSI information based on a buffered channel matrix, and performing reporting. The codebook-based CSI information is used for monitoring the performance of the AI unit.

Optionally, the first CSI is reported by using a higher-layer parameter, such as radio resource control (RRC) or medium access control (MAC). It should be noted that the terminal may report the first CSI or the content of the first CSI, that is, the content of the first CSI is reported directly instead of in the form of CSI. The content is reported by using the higher-layer parameter, that is, the first CSI is reported by using the higher-layer parameter.

Optionally, reporting of the first CSI is associated with a configured grant (CG)-based physical uplink shared channel (PUSCH), such as a type 1 CG, that is, is entirely configured by the RRC.

It should be noted that the network side device may configure reporting of a plurality of pieces of first CSI, and the reporting of the plurality of pieces of first CSI may be configured in a same third CSI report configuration.

Optionally, a CSI reference resource associated with the first CSI includes a CSI reference resource associated with the second CSI. For example, in a case that the network side device configures reporting of a plurality of pieces of first CSI, CSI reference resources associated with the pieces of first CSI include at least corresponding CSI reference resources associated with the second CSI obtained based on the AI unit.

Further, in this case, the reporting, by the terminal, the second CSI includes:
reporting, by the terminal, the second CSI based on a PUSCH of a type 2 configured grant (CG); or
reporting, by the terminal, the second CSI based on a PUSCH of a dynamic grant (DG).

Optionally, the reporting, by the terminal based on the first information, the first CSI and second CSI includes:
when the terminal is in a state of periodically reporting CSI, reporting, by the terminal, the first CSI based on the first information, and reporting the second CSI after a preset period/periods.

For example, when the terminal is in a state of periodically reporting second CSI based on AI, the network side device may notify the terminal of reporting CSI (such as PMI) in a non-AI manner. When the terminal reports CSI in a next time or next several times, CSI (that is, the first CSI) is reported in a codebook manner, and then it is automatically switched to report CSI (that is, the second CSI) based on AI. After receiving the first CSI, the network side device reconstructs a codebook-based precoding matrix, and compares the codebook-based precoding matrix with a precoding matrix/matrices that is/are reconstructed by the second CSI and that is/are received last time or last several times, to determine the performance of the AI unit. In this way, the terminal does not need to report the first CSI and the second CSI every time, thereby effectively reducing transmission overheads.

Optionally, the first information further includes times and a period of reporting the first CSI, so that the network side device can learn times and a period of reporting the first CSI by the terminal for monitoring. This is more conducive to ensuring that the network side device accurately receives the first CSI.

In this embodiment of this application, the second CSI report configuration and the third CSI report configuration correspond to a same CSI resource configuration ID. That is, in a case that the network side device configures two CSI report configurations, the two CSI report configurations may correspond to a same CSI resource configuration ID, where one CSI report configuration indicates reporting of the first CSI, and another CSI report configuration indicates reporting of the second CSI.

In this embodiment of this application, the method may further include the following steps:
receiving, by the terminal, first signaling sent by the network side device; and
buffering, by the terminal in a case that the second CSI is obtained by using the AI unit, a channel measurement result based on the first signaling, and calculating the first CSI based on the channel measurement result; and
the reporting, by the terminal based on the first information, the first CSI includes:
reporting, by the terminal, the first CSI by using an uplink resource.

For example, the network side device sends the first signaling to notify the terminal of monitoring the performance of the AI unit. After receiving the first signaling, the terminal buffers a channel measurement result after obtaining the second CSI by using the AI unit, calculates the codebook-based first CSI by using the same channel measurement result, and sends the first CSI to the network side device through another uplink resource, that is, without a reporting process of CSI.

Optionally, the reporting, by the terminal, the first CSI by using an uplink resource
reporting, by the terminal, the first CSI by using the uplink resource, where the first CSI includes corresponding time-frequency domain information; or
reporting, by the terminal by using the uplink resource, the first CSI, and a codebook PMI and time-frequency domain information corresponding to the first CSI.

That is, the terminal may report corresponding time domain information and frequency domain information in the reported first CSI, or the terminal may report the codebook PMI and the time-frequency domain information corresponding to the first CSI as information other than the first CSI. Furthermore, the network side device can accurately learn time-frequency domain location information corresponding to reporting of the first CSI, to better receive the first CSI.

Optionally, the method further includes:
in a case that the terminal calculates and reports corresponding first CSI for each CSI-RS, if the terminal receives second signaling sent by the network side device, stopping reporting of the first CSI, where the second signaling indicates the terminal to stop reporting of the first CSI.

That is, the terminal may calculate and report corresponding codebook information for each CSI-RS, and the terminal stops reporting of the codebook information until the network side device sends stop signaling.

Optionally, a CSI-RS and the reporting location corresponding to the first CSI are indicated by the network side device.

In this embodiment of this application, the method may further include the following steps:
reporting, by the terminal, a first capability, where the first capability includes at least one of the following:
whether to support monitoring on the performance of the AI unit;
whether to support switching between reporting of the first CSI and reporting of the second CSI; and
a minimum time interval for switching between reporting of the first CSI and reporting of the second CSI.

For example, the terminal may report to the network side device whether to support monitoring on the performance of the AI unit, so that the network side device can determine whether to configure a CSI report configuration for the terminal. Alternatively, the terminal may further report whether to support switching between reporting of the first CSI and reporting of the second CSI, and the minimum time interval between reporting of the first CSI and reporting of the second CSI, so that the network side device can determine when to report the first CSI and when to report the second CSI. This is more conducive to accurately receiving the first CSI and the second CSI by the network side device.

In this embodiment of this application, in a case that the first CSI is reported as a codebook-based PMI, the codebook may be an existing codebook or a known codebook. Alternatively, the codebook may be a codebook obtained by expanding a parameter of the existing codebook, to report more accurate information by using a larger payload. Alternatively, the codebook may be an extension of the existing codebook, using more information of a beam and a delay.

Alternatively, the first CSI (for example, the codebook) may be complete precoded information, that is, coefficients of each subband and each antenna are directly reported without a codebook compression process.

Optionally, in a case that the first CSI includes a codebook-based PMI, and the first CSI is reported by using a higher layer, the PMI satisfies at least one of the following:
(1). all PMIs are reported in one part, that is, there is no distinction between part 1 and part 2; and
(2). determining a fourth parameter based on a third parameter, where the fourth parameter indicates a non-zero coefficient (NZC) bitmap and/or a non-zero coefficient matrix, and the third parameter includes at least one of the following:
a rank indicator (RI);
a quantity of beams selected by the terminal;
a quantity of delays selected by the terminal;
a quantity of non-zero coefficients; and
a proportion of non-zero coefficients to overall coefficients.

It should be noted that different RIs, different quantities of beams selected by the PMI, different quantities of delays selected by the PMI, different quantities of non-zero coefficients, or different proportions of non-zero coefficients to overall coefficients corresponding to different RRC parameters of the non-zero coefficient bitmap and/or the non-zero coefficient matrix. For example, if a quantity of beams selected by the PMI is 6, and a quantity of delays selected by the PMI is 8, a parameter of a bitmap is bitmap68. For another example, if a quantity of non-zero coefficients is 48, an RRC parameter of a non-zero coefficient matrix is NZCSequence_48.

In this embodiment of this application, a new CSI structure may further be provided, and the new CSI structure includes two PMIs, where one PMI is obtained based on the AI unit, and the other PMI is obtained based on the codebook. Optionally, the new CSI structure includes a PMI and a corresponding CSI-RS resource ID or CSI report configuration ID or time-frequency domain information.

Referring to FIG. 3, FIG. 3 is a flowchart of another CSI transmission method according to an embodiment of this application. The method is applied to a network side device. As shown in FIG. 3, the method includes the following steps.

Step 301: A network side device receives first CSI reported by a terminal based on first information, or receive the first CSI and second CSI reported by the terminal based on the first information.

The first information indicates a reporting location of the first CSI, the first CSI is CSI used for monitoring performance of an AI unit, and the second CSI is CSI obtained based on the AI unit.

Optionally, the method further includes any one of the following:
sending, by the network side device, a first CSI report configuration to the terminal, where the first CSI report configuration indicates the reporting location of the first CSI and a reporting location of the second CSI;
sending, by the network side device, a second CSI report configuration and/or a third CSI report configuration to the terminal, where the second CSI report configuration indicates the reporting location of the second CSI, and the third CSI report configuration indicates the reporting location of the first CSI; and
sending, by the network side device, first indication information to the terminal, where the first indication information indicates at least one of the following:
a first CSI report configuration identity (ID), where the first CSI report configuration ID indicates a location of an RS corresponding to the second CSI;
a CSI-RS resource, where the CSI-RS resource is associated with the reporting location of the first CSI and the reporting location of the second CSI; and
a time-frequency location in which the first CSI is reported and/or a time-frequency location in which the second CSI is reported.

Optionally, the first CSI report configuration ID further indicates the reporting location of the second CSI; and
configuration information of a codebook, where CSI reported by the terminal is reported by using codebook-based channel information.

Optionally, before the sending, by the network side device, a second CSI report configuration and/or a third CSI report configuration to the terminal, the method further includes:
sending, by the network side device, second indication information to the terminal, where the second indication information indicates the terminal to report CSI information.

Optionally, the receiving, by the network side device, the second CSI reported by the terminal includes:
receiving, by the network side device, the second CSI reported by the terminal based on a PUSCH of a type 2 configured grant; or
receiving, by the network side device, the second CSI reported by the terminal based on a PUSCH of a dynamic grant.

Optionally, the receiving, by the network side device, the first CSI and second CSI
reported by the terminal includes:

when the terminal is in a state of periodically reporting CSI, receiving, by the network side device, the first CSI reported by the terminal, and receiving the second CSI reported by the terminal after a preset period/periods.

Optionally, the method further includes:
sending, by the network side device, first signaling to the terminal, where the first signaling is used for buffering a channel measurement result in a case that the terminal obtains the second CSI by using the AI unit, and calculating the first CSI based on the channel measurement result; and
the receiving, by a network side device, first CSI reported by a terminal based on first information includes:
receiving, by the network side device, the first CSI reported by the terminal by using an uplink resource.

Optionally, the method further includes:
sending, by the network side device, second signaling to the terminal, where the second signaling indicates the terminal to stop reporting of the first CSI.

Optionally, the receiving, by the network side device, the first CSI reported by the terminal by using an uplink resource includes:
receiving, by the network side device, the first CSI reported by the terminal by using the uplink resource, where the first CSI includes corresponding time-frequency domain information; or
receiving, by the network side device, the first CSI, and a PMI and time-frequency domain information corresponding to the first CSI reported by the terminal by using the uplink resource.

Optionally, the method further includes:
indicating, by the network side device, a CSI-RS and the reporting location corresponding to the first CSI to the terminal.

Optionally, the method further includes:
receiving, by the network side device, a first capability reported by the terminal, where the first capability includes at least one of the following:
whether the terminal supports monitoring on the performance of the AI unit;
whether the terminal supports switching between reporting of the first CSI and reporting of the second CSI; and
a minimum time interval at which the terminal switches between reporting of the first CSI and reporting of the second CSI.

It should be noted that, the CSI transmission method provided in this embodiment of this application is applied to the network side device, and is corresponding to the method applied to the terminal side. For a related concept and a specific implementation process in this embodiment of this application, refer to the description in the terminal side embodiment. To avoid repetition, details are not described in this embodiment.

In this embodiment of this application, the terminal reports the first CSI used for monitoring the performance of the AI unit, or reports the first CSI and the second CSI obtained based on the AI unit, so that the network side device can determine the performance of the AI unit. Therefore, there is no need to transmit the AI unit between the terminal and the network side device to determine the performance of the AI unit. This effectively reduces transmission overheads between the terminal and the network side device.

The CSI transmission method provided in this embodiment of this application may be executed by a CSI transmission apparatus. In this embodiment of this application, that the CSI transmission apparatus performs the CSI transmission method is used as an example to describe the CSI transmission apparatus provided in this embodiment of this application.

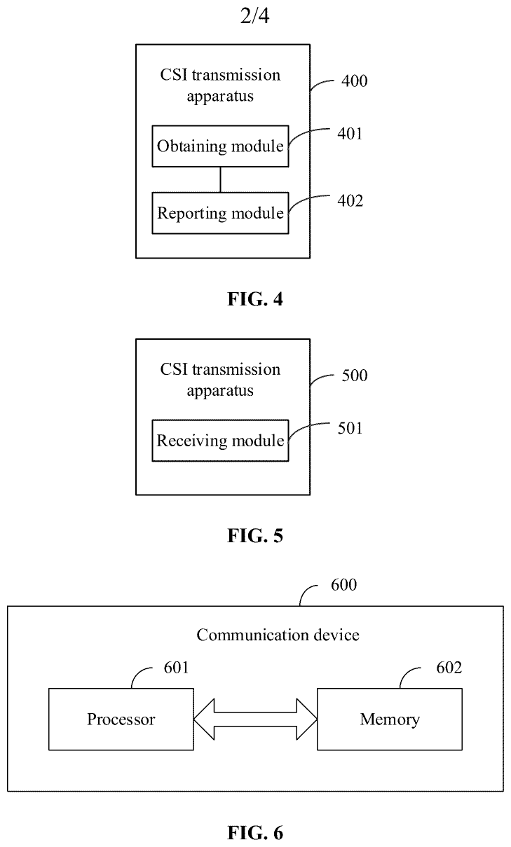

Referring to FIG. 4, FIG. 4 is a structural diagram of a CSI transmission apparatus according to an embodiment of this application. As shown in FIG. 4, the CSI transmission apparatus 400 includes:
an obtaining module 401, configured to obtain first information, where the first information indicates a reporting location of first CSI, and the first CSI is CSI used for monitoring performance of an AI unit; and
a reporting module 402, configured to report the first CSI or report the first CSI and second CSI based on the first information, where the second CSI is CSI obtained based on the AI unit.

Optionally, the first information further indicates a reporting location of the second CSI.

Optionally, the obtaining module 401 is further configured to perform any one of the following:
obtaining a first CSI report configuration configured by a network side device, where the first CSI report configuration indicates the reporting location of the first CSI and the reporting location of the second CSI;
obtaining a second CSI report configuration and/or a third CSI report configuration configured by the network side device, where the second CSI report configuration indicates the reporting location of the second CSI, and the third CSI report configuration indicates the reporting location of the first CSI; and
receiving first indication information sent by the network side device, where the first indication information indicates at least one of the following:
a first CSI report configuration identity (ID), where the first CSI report configuration ID indicates a location of an RS corresponding to the second CSI;
a CSI-RS resource, where the CSI-RS resource is associated with the reporting location of the first CSI and the reporting location of the second CSI;
a time-frequency location in which the first CSI is reported and/or a time-frequency location in which the second CSI is reported; and
configuration information of a codebook, where CSI reported by the terminal is reported by using codebook-based channel information.

Optionally, the first CSI report configuration ID further indicates the reporting location of the second CSI.

Optionally, the first CSI report configuration includes at least one of the following:
a first CSI resource, where the first CSI resource is used for calculating the first CSI and the second CSI, and the first CSI and the second CSI correspond to a same CSI-RS; and
the first CSI and the second CSI are associated with a same CSI reference resource.

Optionally, in a case that the first CSI and the second CSI correspond to the same CSI-RS, the reporting module 402 is further configured to:
determine, based on the first CSI report configuration, a time domain location of the CSI-RS corresponding to the first CSI and the second CSI; and
report the first CSI and the second CSI after the time domain location of the CSI-RS.

Optionally, in a case that the first CSI and the second CSI are associated with a same CSI reference resource, the apparatus further includes an association module, configured to:
determine a first CSI reference resource based on the reporting location of the second CSI; and
associate the first CSI with the first CSI reference resource.

Optionally, a time domain location corresponding to the first CSI reference resource is before or after a time domain location of the first CSI report configuration.

Optionally, in a case that the first CSI and the second CSI are associated with a same CSI reference resource, the first CSI corresponds to a first CSI-RS, the second CSI corresponds to a second CSI-RS, and the first CSI-RS is associated with the second CSI-RS.

Optionally, the first CSI report configuration includes at least one of the following:
a first CSI resource configuration and a second CSI resource configuration, where the first CSI resource configuration corresponds to the first CSI, and the second CSI resource configuration corresponds to the second CSI;
a first CSI resource configuration, where the first CSI resource configuration includes a first CSI-RS resource set list and a second CSI-RS resource set list, the first CSI-RS resource set list corresponds to the first CSI, and the second CSI-RS resource set list corresponds to the second CSI;
a first CSI resource configuration, where the first CSI resource configuration includes a first CSI-RS resource set list, the first CSI-RS resource set list includes a first CSI-RS resource set and a second CSI-RS resource set, the first CSI-RS resource set corresponds to the first CSI, and the second CSI-RS resource set corresponds to the second CSI;
a first CSI resource configuration, where the first CSI resource configuration includes a first CSI-RS resource set list, the first CSI-RS resource set list includes a first CSI-RS resource set, the first CSI-RS resource set includes a first CSI-RS and a second CSI-RS, the first CSI-RS corresponds to the first CSI, and the second CSI-RS corresponds to the second CSI;
the time-frequency location in which the first CSI is reported and the time-frequency location in which the second CSI is reported; and
a bandwidth part in which the first CSI is reported and a bandwidth part in which the second CSI is reported.

Optionally, in a case that the first CSI report configuration includes the first CSI resource configuration and the second CSI resource configuration, the first CSI resource configuration and the second CSI resource configuration further satisfy at least one of the following:
corresponding resource types are different; and
included CSI-RS resource set lists are different.

Optionally, in a case that the first CSI report configuration includes a first CSI resource configuration, and the first CSI resource configuration includes a first CSI-RS resource set list and a second CSI-RS resource set list, the first CSI-RS resource set list is an expanded resource set list of CSI for indicating to calculate the performance of the AI unit.

Optionally, in a case that the first CSI report configuration includes a first CSI resource configuration, the first CSI resource configuration includes a first CSI-RS resource set list, and the first CSI-RS resource set list includes a first CSI-RS resource set and a second CSI-RS resource set, the first CSI-RS resource set and the second CSI-RS resource set further satisfy at least one of the following:
content of the first CSI-RS resource set is the same as content of the second CSI-RS resource set, and a CSI-RS in the first CSI-RS resource set is used for calculating both the first CSI and the second CSI;
the first CSI-RS resource set is associated with the second CSI-RS resource set, and the content of the first CSI-RS resource set is different from the content of the second CSI-RS resource set; and
the first CSI-RS resource set and the second CSI-RS resource set are specified by a protocol.

Optionally, the third CSI report configuration includes a CSI report configuration ID, and the apparatus further includes:
an estimation module, configured to perform channel estimation based on a CSI-RS resource in a CSI report configuration corresponding to the CSI report configuration ID.

Optionally, the apparatus further includes:
a first receiving module, configured to receive second indication information sent by the network side device, where the second indication information indicates the terminal to report CSI information.

Optionally, the reporting module 402 is further configured to:
calculate corresponding codebook-based CSI information based on a buffered channel matrix, and performs reporting.

Optionally, the first CSI is reported by using a higher-layer parameter.

Optionally, reporting of the first CSI is associated with a configured grant-based PUSCH.

Optionally, a CSI reference resource associated with the first CSI includes a CSI reference resource associated with the second CSI.

Optionally, the reporting module 402 is further configured to:
report the second CSI based on a PUSCH of a type 2 configured grant; or
report the second CSI based on a PUSCH of a dynamic grant.

Optionally, in a case that the first indication information indicates the configuration information of the codebook, the configuration information of the codebook includes a second parameter for indicating a first parameter, the first parameter includes a non-zero coefficient bitmap and/or a non-zero coefficient matrix, and the second parameter includes at least one of the following:
a rank indicator;
a quantity of beams selected by the terminal;
a quantity of delays selected by the terminal;
a quantity of non-zero coefficients; and
a proportion of non-zero coefficients to overall coefficients.

Optionally, in a case that the configuration information of the codebook is indicated by using a higher-layer parameter, a higher-layer parameter corresponding to the first parameter is related to a value of the second parameter.

Optionally, the reporting module 402 is further configured to:
when being in a state of periodically reporting CSI, report the first CSI based on the first information, and report the second CSI after a preset period/periods.

Optionally, the first information includes times and a period of reporting the first CSI.

Optionally, the apparatus further includes:
a second receiving module, configured to receive first signaling sent by the network side device; and
a calculation module, configured to: buffer, in a case that the second CSI is obtained by using the AI unit, a channel measurement result based on the first signaling, and calculate the first CSI based on the channel measurement result, where
the reporting module 402 is further configured to:
report the first CSI by using an uplink resource.

Optionally, the apparatus further includes:
a third receiving module, configured to: in a case that corresponding first CSI is calculated and reported for each CSI-RS, if second signaling sent by the network side device is received, stop reporting of the first CSI, where the second signaling indicates the apparatus to stop reporting of the first CSI.

Optionally, the reporting module 402 is further configured to:
report the first CSI by using the uplink resource, where the first CSI includes corresponding time-frequency domain information; or
report, by using the uplink resource, the first CSI, and a codebook precoding matrix indicator (PMI) and time-frequency domain information corresponding to the first CSI.

Optionally, a CSI-RS and the reporting location corresponding to the first CSI are indicated by the network side device.

Optionally, the second CSI report configuration and the third CSI report configuration correspond to a same CSI resource configuration ID.

Optionally, the reporting module 402 is further configured to:
report a first capability, where the first capability includes at least one of the following:
whether to support monitoring on the performance of the AI unit;
whether to support switching between reporting of the first CSI and reporting of the second CSI; and
a minimum time interval for switching between reporting of the first CSI and reporting of the second CSI.

Optionally, in a case that the first CSI includes a codebook-based PMI, and the first CSI is reported by using a higher layer, the PMI satisfies at least one of the following:
all PMIs are reported in one part; and
determining a fourth parameter based on a third parameter, where the fourth parameter indicates a non-zero coefficient bitmap and/or a non-zero coefficient matrix, and the third parameter includes at least one of the following:
a rank indicator;
a quantity of beams selected by the terminal;
a quantity of delays selected by the terminal;
a quantity of non-zero coefficients; and
a proportion of non-zero coefficients to overall coefficients.

Optionally, the first CSI is complete precoded information.

In this embodiment of this application, the terminal reports the first CSI used for monitoring the performance of the AI unit, or reports the first CSI and the second CSI obtained based on the AI unit, so that the network side device can determine the performance of the AI unit. Therefore, there is no need to transmit the AI unit between the terminal and the network side device to determine the performance of the AI unit. This effectively reduces transmission overheads between the terminal and the network side device.

The CSI transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The CSI transmission apparatus provided in this embodiment of this application can implement the processes implemented in the method embodiment of FIG. 2 and achieve same technical effect. To avoid repetition, details are not described herein again.

Referring to FIG. 5, FIG. 5 is a structural diagram of another CSI transmission apparatus according to an embodiment of this application. As shown in FIG. 5, the CSI transmission apparatus 500 includes:
a receiving module 501, configured to: receive first CSI reported by a terminal based on first information, or receive the first CSI and second CSI reported by the terminal based on the first information, where
the first information indicates a reporting location of the first CSI, the first CSI is CSI used for monitoring performance of an AI unit, and the second CSI is CSI obtained based on the AI unit.

Optionally, the apparatus further includes a sending module, configured to perform any one of the following:
sending a first CSI report configuration to the terminal, where the first CSI report configuration indicates the reporting location of the first CSI and a reporting location of the second CSI;
sending a second CSI report configuration and/or a third CSI report configuration to the terminal, where the second CSI report configuration indicates the reporting location of the second CSI, and the third CSI report configuration indicates the reporting location of the first CSI; and
sending first indication information to the terminal, where the first indication information indicates at least one of the following:
a first CSI report configuration identity (ID), where the first CSI report configuration ID indicates a location of an RS corresponding to the second CSI;
a CSI-RS resource, where the CSI-RS resource is associated with the reporting location of the first CSI and the reporting location of the second CSI;
a time-frequency location in which the first CSI is reported and/or a time-frequency location in which the second CSI is reported; and
configuration information of a codebook, where CSI reported by the terminal is reported by using codebook-based channel information.

Optionally, the first CSI report configuration ID further indicates the reporting location of the second CSI.

Optionally, the sending module is further configured to:
send second indication information to the terminal, where the second indication information indicates the terminal to report CSI information.

Optionally, the receiving module 501 is further configured to:
receive the second CSI reported by the terminal based on a PUSCH of a type 2 configured grant; or
receive the second CSI reported by the terminal based on a PUSCH of a dynamic grant.

Optionally, the receiving module 501 is further configured to:
when the terminal is in a state of periodically reporting CSI, receive the first CSI reported by the terminal, and receive the second CSI reported by the terminal after a preset period/periods.

Optionally, the sending module is further configured to:
send first signaling to the terminal, where the first signaling is used for buffering a channel measurement result in a case that the terminal obtains the second CSI by using the AI unit, and calculate the first CSI based on the channel measurement result; and
the receiving module 501 is further configured to:
receive the first CSI reported by the terminal by using an uplink resource.

Optionally, the sending module is further configured to:
send second signaling to the terminal, where the second signaling indicates the terminal to stop reporting of the first CSI.

Optionally, the receiving module 501 is further configured to:
receive the first CSI reported by the terminal by using the uplink resource, where the first CSI includes corresponding time-frequency domain information; or
receive the first CSI, and a PMI and time-frequency domain information corresponding to the first CSI reported by the terminal by using the uplink resource.

Optionally, the apparatus further includes:
an indication module, configured to indicate a CSI-RS and the reporting location corresponding to the first CSI to the terminal.

Optionally, the receiving module 501 is further configured to:
receive a first capability reported by the terminal, where the first capability includes at least one of the following:
whether the terminal supports monitoring on the performance of the AI unit;
whether the terminal supports switching between reporting of the first CSI and reporting of the second CSI; and
a minimum time interval at which the terminal switches between reporting of the first CSI and reporting of the second CSI.

The CSI transmission apparatus provided in this embodiment of this application can implement the processes implemented in the method embodiment of FIG. 3 and achieve same technical effect. To avoid repetition, details are not described herein again.

Optionally, as shown in FIG. 6, an embodiment of this application further provides a communication device 600, including a processor 601 and a memory 602, and the memory 602 stores a program or an instruction that can be run on the processor 601. For example, in a case that the communication device 600 is a terminal, when the program or the instruction is executed by the processor 601, the steps of the foregoing method embodiment in FIG. 2 are implemented, and a same technical effect can be achieved. In a case that the communication device 600 is a network side device, when the program or the instruction is executed by the processor 601, the steps of the method embodiment in FIG. 3 are implemented, and a same technical effect can be achieved. To avoid repetition, details are not described herein again.

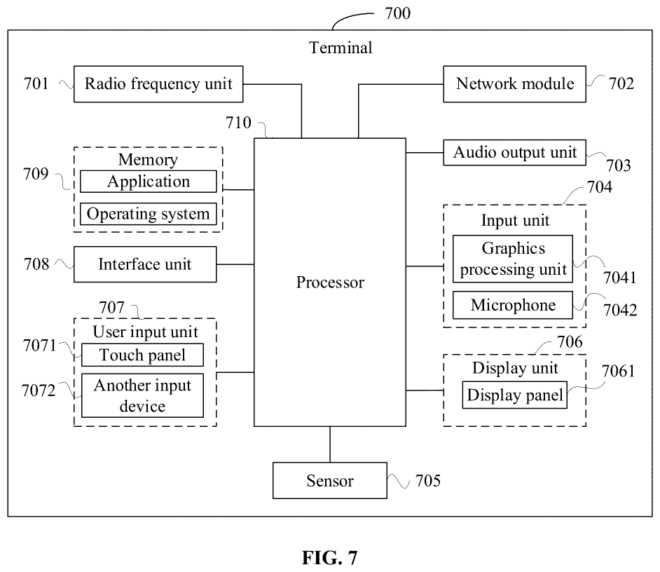

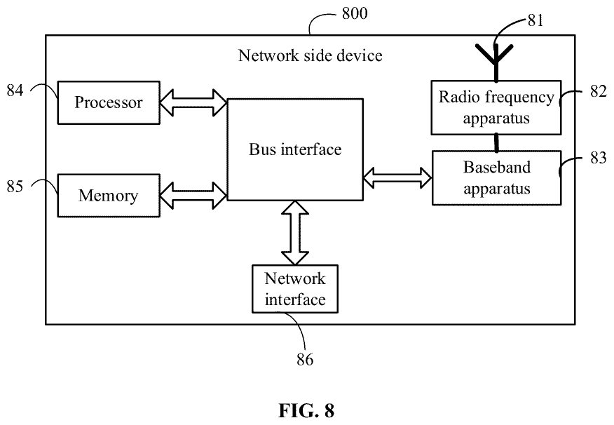

An embodiment of this application further provides a terminal, including a processor and a communication interface. The processor is configured to obtain first information, where the first information indicates a reporting location of first CSI, and the first CSI is CSI used for monitoring performance of an AI unit; and the communication interface is configured to report the first CSI or report the first CSI and second CSI based on the first information, where the second CSI is CSI obtained based on the AI unit. The terminal embodiment is corresponding to the method embodiment on the terminal side, each implementation process and implementation of the method embodiment can be applied to the terminal embodiment, and a same technical effect can be achieved. Specifically, FIG. 7 is a schematic diagram of a hardware structure of a terminal according to an embodiment of this application.

The terminal 700 includes but is not limited to at least a part of components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that in this embodiment of this application, the input unit 704 may include a graphics processing unit (GPU) 7041 and a microphone 7042. The graphics processing unit 7041 processes image data of a static picture or a video obtained by an image capture apparatus (for example, a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Generally, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 709 in this embodiment of this application includes but is not limited to these memories and any memory of another proper type.

The processor 710 may include one or more processing units. Optionally, an application processor and a modem processor are integrated into the processor 710. The application processor mainly processes an operating system, a user interface, an application, or the like. The modem processor mainly processes a wireless communication signal, for example, a baseband processor. It may be understood that, alternatively, the modem processor may not be integrated into the processor 710.

The processor 710 is configured to obtain first information, where the first information indicates a reporting location of first CSI, and the first CSI is CSI used for monitoring performance of an artificial intelligence (AI) unit; and
the radio frequency unit 701 is configured to report the first CSI or report the first CSI and second CSI based on the first information, where the second CSI is CSI obtained based on the AI unit.

In this embodiment of this application, the terminal reports the first CSI used for monitoring the performance of the AI unit, or reports the first CSI and the second CSI obtained based on the AI unit, so that the network side device can determine the performance of the AI unit. Therefore, there is no need to transmit the AI unit between the terminal and the network side device to determine the performance of the AI unit. This effectively reduces transmission overheads between the terminal and the network side device.

An embodiment of this application further provides a network side device, including a processor and a communication interface. The communication interface is configured to: receive first CSI reported by a terminal based on first information, or receive the first CSI and second CSI reported by the terminal based on the first information, where the first information indicates a reporting location of the first CSI, the first CSI is CSI used for monitoring performance of an AI unit, and the second CSI is CSI obtained based on the AI unit. This network side device embodiment is corresponding to the foregoing method embodiment of the network side device. Each implementation process and implementation of the foregoing method embodiment may be applicable to this network side device embodiment, and a same technical effect can be achieved.

Specifically, an embodiment of this application further provides a network side device. As shown in FIG. 8, the network side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information through the antenna 81.

In the foregoing embodiment, the method performed by the network side device may be implemented in the baseband apparatus 83. The baseband apparatus 83 includes a baseband processor.

For example, the baseband apparatus 83 may include at least one baseband board. A plurality of chips are disposed on the baseband board. As shown in FIG. 8, one chip is, for example, a baseband processor, and is connected to the memory 85 by using a bus interface, to invoke a program in the memory 85 to perform the operations of the network device shown in the foregoing method embodiment.

The network side device may further include a network interface 86, and the interface is, for example, a common public radio interface (CPRI).

Specifically, the network side device 800 in this embodiment of this application further includes an instruction or a program that is stored in the memory 85 and that can be run on the processor 84. The processor 84 invokes the instruction or the program in the memory 85 to perform the method performed by the modules shown in FIG. 5, and a same technical effect is achieved. To avoid repetition, details are not described herein again.

An embodiment of this application further provides a readable storage medium. The readable storage medium stores a program or an instruction, and when the program or the instruction is executed by a processor, the processes of the method embodiment in FIG. 2 are implemented, or the processes of the method embodiment in FIG. 3 are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the method embodiment in FIG. 2 or implement the processes of the method embodiment in FIG. 3, and a same technical effect can be achieved. To avoid repetition, details are not described herein again.

It should be understood that the chip mentioned in this embodiment of this application may also be referred to as a system-level chip, a system chip, a chip system, an on-chip system chip, or the like.

An embodiment of this application further provides a computer program product, the computer program product is stored in a storage medium, and the computer program product is executed by at least one processor to implement the processes of the method embodiment in FIG. 2 or implement the processes of the method embodiment in FIG. 3, and a same technical effect can be achieved. To avoid repetition, details are not described herein again.

An embodiment of this application further provides a communication system, including a terminal and a network side device. The terminal may be configured to perform the steps of the method in FIG. 2, and the network side device may be configured to perform the steps of the method in FIG. 3.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the related art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A channel state information (CSI) transmission method, comprising:
obtaining, by a terminal, first information, wherein the first information indicates a reporting location of first CSI, and the first CSI is CSI used for monitoring performance of an artificial intelligence (AI) unit; and
reporting, by the terminal based on the first information, the first CSI, or reporting the first CSI and second CSI, wherein the second CSI is CSI obtained based on the AI unit.

2. The method according to claim 1, wherein the first information further indicates a reporting location of the second CSI.

3. The method according to claim 2, wherein the obtaining, by a terminal, first information comprises any one of the following:
obtaining, by the terminal, a first CSI report configuration configured by a network side device, wherein the first CSI report configuration indicates the reporting location of the first CSI and the reporting location of the second CSI;
obtaining, by the terminal, a second CSI report configuration and/or a third CSI report configuration configured by the network side device, wherein the second CSI report configuration indicates the reporting location of the second CSI, and the third CSI report configuration indicates the reporting location of the first CSI; or
receiving, by the terminal, first indication information sent by the network side device, wherein the first indication information indicates at least one of the following:
a first CSI report configuration identity (ID), wherein the first CSI report configuration ID indicates a location of a reference signal (RS) corresponding to the second CSI;
a CSI-RS resource, wherein the CSI-RS resource is associated with the reporting location of the first CSI and the reporting location of the second CSI;
a time-frequency location in which the first CSI is reported and/or a time-frequency location in which the second CSI is reported; or
configuration information of a codebook, wherein CSI reported by the terminal is reported by using codebook-based channel information.

4. The method according to claim 3, wherein the first CSI report configuration ID further indicates the reporting location of the second CSI.

5. The method according to claim 4, wherein the first CSI report configuration comprises at least one of the following:
a first CSI resource, wherein the first CSI resource is used for calculating the first CSI and the second CSI, and the first CSI and the second CSI correspond to a same CSI-RS; or
the first CSI and the second CSI are associated with a same CSI reference resource.

6. The method according to claim 5, wherein in a case that the first CSI and the second CSI correspond to the same CSI-RS, the reporting, by the terminal based on the first information, the first CSI and second CSI comprises:
determining, by the terminal based on the first CSI report configuration, a time domain location of the CSI-RS corresponding to the first CSI and the second CSI; and
reporting, by the terminal, the first CSI and the second CSI after the time domain location of the CSI-RS.

7. The method according to claim 5, wherein in a case that the first CSI and the second CSI are associated with a same CSI reference resource, the method further comprises:
determining, by the terminal, a first CSI reference resource based on the reporting location of the second CSI; and
associating, by the terminal, the first CSI with the first CSI reference resource.

8. The method according to claim 7, wherein a time domain location corresponding to the first CSI reference resource is before or after a time domain location of the first CSI report configuration.

9. The method according to claim 5, wherein in a case that the first CSI and the second CSI are associated with a same CSI reference resource, the first CSI corresponds to a first CSI-RS, the second CSI corresponds to a second CSI-RS, and the first CSI-RS is associated with the second CSI-RS.

10. The method according to claim 3, wherein the first CSI report configuration comprises at least one of the following:
a first CSI resource configuration and a second CSI resource configuration, wherein the first CSI resource configuration corresponds to the first CSI, and the second CSI resource configuration corresponds to the second CSI;
a first CSI resource configuration, wherein the first CSI resource configuration comprises a first CSI-RS resource set list and a second CSI-RS resource set list, the first CSI-RS resource set list corresponds to the first CSI, and the second CSI-RS resource set list corresponds to the second CSI;
a first CSI resource configuration, wherein the first CSI resource configuration comprises a first CSI-RS resource set list, the first CSI-RS resource set list comprises a first CSI-RS resource set and a second CSI-RS resource set, the first CSI-RS resource set corresponds to the first CSI, and the second CSI-RS resource set corresponds to the second CSI;
a first CSI resource configuration, wherein the first CSI resource configuration comprises a first CSI-RS resource set list, the first CSI-RS resource set list comprises a first CSI-RS resource set, the first CSI-RS resource set comprises a first CSI-RS and a second CSI-RS, the first CSI-RS corresponds to the first CSI, and the second CSI-RS corresponds to the second CSI;
the time-frequency location in which the first CSI is reported and the time-frequency location in which the second CSI is reported; or
a bandwidth part in which the first CSI is reported and a bandwidth part in which the second CSI is reported.

11. The method according to claim 10, wherein in a case that the first CSI report configuration comprises the first CSI resource configuration and the second CSI resource configuration, the first CSI resource configuration and the second CSI resource configuration further satisfy at least one of the following:
corresponding resource types are different; or
comprised CSI-RS resource set lists are different; or,
wherein in a case that the first CSI report configuration comprises a first CSI resource configuration, and the first CSI resource configuration comprises a first CSI-RS resource set list and a second CSI-RS resource set list, the first CSI-RS resource set list is an expanded resource set list of CSI for indicating to calculate the performance of the AI unit; or,
wherein in a case that the first CSI report configuration comprises a first CSI resource configuration, the first CSI resource configuration comprises a first CSI-RS resource set list, and the first CSI-RS resource set list comprises a first CSI-RS resource set and a second CSI-RS resource set, the first CSI-RS resource set and the second CSI-RS resource set further satisfy at least one of the following:
content of the first CSI-RS resource set is the same as content of the second CSI-RS resource set, and a CSI-RS in the first CSI-RS resource set is used for calculating both the first CSI and the second CSI;
the first CSI-RS resource set is associated with the second CSI-RS resource set, and the content of the first CSI-RS resource set is different from the content of the second CSI-RS resource set; or
the first CSI-RS resource set and the second CSI-RS resource set are specified by a protocol.

12. The method according to claim 3, wherein the third CSI report configuration comprises a CSI report configuration ID, and the method further comprises:
performing, by the terminal, channel estimation based on a CSI-RS resource in a CSI report configuration corresponding to the CSI report configuration ID; or,
wherein before the obtaining, by the terminal, a second CSI report configuration and/or a third CSI report configuration configured by the network side device, the method further comprises:
receiving, by the terminal, second indication information sent by the network side device, wherein the second indication information indicates the terminal to report CSI information; or,
wherein the reporting, by the terminal based on the first information, the first CSI comprises:
calculating, by the terminal, corresponding codebook-based CSI information based on a buffered channel matrix, and performing reporting; or,
wherein the first CSI is reported by using a higher-layer parameter;
wherein reporting of the first CSI is associated with a configured grant-based physical uplink shared channel (PUSCH).

13. The method according to claim 3, wherein a CSI reference resource associated with the first CSI comprises a CSI reference resource associated with the second CSI; or,
wherein the reporting, by the terminal, the second CSI comprises:
reporting, by the terminal, the second CSI based on a PUSCH of a type 2 configured grant; or
reporting, by the terminal, the second CSI based on a PUSCH of a dynamic grant; or,
wherein in a case that the first indication information indicates configuration information of a codebook, the configuration information of the codebook comprises a second parameter for indicating a first parameter, the first parameter comprises a parameter/parameters of a non-zero coefficient bitmap and/or a non-zero coefficient matrix, and the second parameter comprises at least one of the following:
a rank indicator;
a quantity of beams selected by the terminal;
a quantity of delays selected by the terminal;
a quantity of non-zero coefficients; or
a proportion of non-zero coefficients to overall coefficients;
wherein in a case that the configuration information of the codebook is indicated by using a higher-layer parameter, a higher-layer parameter corresponding to the first parameter is related to a value of the second parameter.

14. A CSI transmission method, comprising:
receiving, by a network side device, first CSI reported by a terminal based on first information, or receiving the first CSI and second CSI reported by the terminal based on the first information, wherein
the first information indicates a reporting location of the first CSI, the first CSI is CSI used for monitoring performance of an AI unit, and the second CSI is CSI obtained based on the AI unit.

15. The method according to claim 14, wherein the method further comprises any one of the following:
sending, by the network side device, a first CSI report configuration to the terminal, wherein the first CSI report configuration indicates the reporting location of the first CSI and a reporting location of the second CSI;
sending, by the network side device, a second CSI report configuration and/or a third CSI report configuration to the terminal, wherein the second CSI report configuration indicates the reporting location of the second CSI, and the third CSI report configuration indicates the reporting location of the first CSI; or
sending, by the network side device, first indication information to the terminal, wherein the first indication information indicates at least one of the following:
a first CSI report configuration identity (ID), wherein the first CSI report configuration ID indicates a location of an RS corresponding to the second CSI;
a CSI-RS resource, wherein the CSI-RS resource is associated with the reporting location of the first CSI and the reporting location of the second CSI;
a time-frequency location in which the first CSI is reported and/or a time-frequency location in which the second CSI is reported; or
configuration information of a codebook, wherein CSI reported by the terminal is reported by using codebook-based channel information.

16. The method according to claim 15, wherein the first CSI report configuration ID further indicates the reporting location of the second CSI; or,
wherein before the sending, by the network side device, a second CSI report configuration and/or a third CSI report configuration to the terminal, the method further comprises:
sending, by the network side device, second indication information to the terminal, wherein the second indication information indicates the terminal to report CSI information.

17. The method according to claim 14, wherein the receiving, by the network side device, the second CSI reported by the terminal comprises:
receiving, by the network side device, the second CSI reported by the terminal based on a PUSCH of a type 2 configured grant; or
receiving, by the network side device, the second CSI reported by the terminal based on a PUSCH of a dynamic grant; or,
wherein the receiving, by the network side device, the first CSI and second CSI reported by the terminal comprises:
when the terminal is in a state of periodically reporting CSI, receiving, by the network side device, the first CSI reported by the terminal, and receiving the second CSI reported by the terminal after a preset period/periods.

18. The method according to claim 14, wherein the method further comprises:
sending, by the network side device, first signaling to the terminal, wherein the first signaling is used for buffering a channel measurement result in a case that the terminal obtains the second CSI by using the AI unit, and calculating the first CSI based on the channel measurement result; and
the receiving, by a network side device, first CSI reported by a terminal based on first information comprises:
receiving, by the network side device, the first CSI reported by the terminal by using an uplink resource; or,
wherein the method further comprises:
sending, by the network side device, second signaling to the terminal, wherein the second signaling indicates the terminal to stop reporting of the first CSI; or,
wherein the receiving, by the network side device, the first CSI reported by the terminal by using an uplink resource comprises:
receiving, by the network side device, the first CSI reported by the terminal by using the uplink resource, wherein the first CSI comprises corresponding time-frequency domain information; or
receiving, by the network side device, the first CSI, and a PMI and time-frequency domain information corresponding to the first CSI reported by the terminal by using the uplink resource; or,
wherein the method further comprises:
indicating, by the network side device, a CSI-RS and the reporting location corresponding to the first CSI to the terminal.

19. A terminal, comprising a processor and a memory, wherein the memory stores a program or an instruction that can be run on the processor, wherein the program or the instruction, when executed by the processor, causes the terminal to perform:
obtaining first information, wherein the first information indicates a reporting location of first CSI, and the first CSI is CSI used for monitoring performance of an artificial intelligence (AI) unit; and
reporting, based on the first information, the first CSI, or reporting the first CSI and second CSI, wherein the second CSI is CSI obtained based on the AI unit.

20. A network side device, comprising a processor and a memory, wherein the memory stores a program or an instruction that can be run on the processor, and when the program or the instruction is executed by the processor, the steps of the CSI transmission method according to claim 14 are implemented.
